(19) United States
(12) Patent Application Publication
(10) Pub. No.: US 2024/0295768 A1
(43) Pub. Date: Sep. 5, 2024

(54) DISPLAY DEVICE

(71) Applicant: Japan Display Inc., Tokyo (JP)

(72) Inventor: Yoshinori TANAKA, Tokyo (JP)

(21) Appl. No.: 18/586,835

(22) Filed: Feb. 26, 2024

(30) Foreign Application Priority Data
Mar. 2, 2023 (JP) 2023-031980

(51) Int. Cl. G02F 1/1335

(52) U.S. Cl. CPC G02F 1/133502; G02F 2203/01

(57) ABSTRACT

A display device including a first substrate, a second substrate, a liquid crystal layer arranged between the first substrate and the second substrate, a first light guide plate adhered and fixed to the first substrate via a first adhesive layer, a second light guide plate adhered and fixed to the second substrate via a second adhesive layer, a light source unit arranged at a position facing a first side surface of the second light guide plate, and a low refractive index layer interposed in a part of a region between the second light guide plate and the second adhesive layer and having a refractive index lower than that of the first light guide plate, in which a thickness of the low refractive index layer is larger than 800 nm is used.

### CROSS REFERENCES TO RELATED APPLICATIONS

The present application claims priority to Japanese Patent Application No. 2023-031980 filed on Mar. 2, 2023, the disclosure of which is incorporated herein by reference.

### TECHNICAL FIELD

The present invention relates to a display device using a liquid crystal layer.

### BACKGROUND

As a display device using a liquid crystal layer, there is a transparent display device in which light transmittance of substrates sandwiching a liquid crystal layer is improved, whereby an observer can recognize a display image and a background superimposed on each other. Patent Document 1 (Japanese Unexamined Patent Application Publication No. 2020-16724) discloses that a transparent layer having a refractive index lower than that of a transparent substrate whose side surface faces a light emitting element is provided in order to prevent light attenuation in a transparent display device.

### SUMMARY

The inventor of this application has been developing a transparent display device with which an observer can recognize a display image and a background superimposed on each other. In the case of a transparent display device, each of front and back surfaces needs to have the property of transmitting visible light. Therefore, a light source unit for displaying images is arranged on a side surface of a light guide plate. According to studies by the inventor of this application, it has been found that the following problem occurs when a light source unit is arranged so as to face a side surface of a light guide plate. Namely, when a low refractive index layer with a refractive index lower than that of a light guide plate whose side surface faces a light emitting element is provided in order to prevent light attenuation in a transparent display device, a reflectivity on a surface of the low refractive index layer is lowered if a thickness of the low refractive index layer is small, so that a problem arises in that an effect expected by providing the low refractive index layer cannot be sufficiently obtained.

An object of the present invention is to provide a technique capable of improving the performance of a display device.

Other objects and novel features will be apparent from the description of this specification and accompanying drawings.

An outline of a typical embodiment disclosed in this application will be briefly described as follows.

A display device according to an embodiment includes a first substrate having a first front surface and a first back surface on an opposite side of the first front surface, a second substrate having a second back surface facing the first front surface and a second front surface on an opposite side of the second back surface, a liquid crystal layer arranged between the first front surface of the first substrate and the second back surface of the second substrate, a first light guide plate adhered and fixed to the first back surface of the first substrate via a first adhesive layer, a second light guide plate adhered and fixed to the second front surface of the second substrate via a second adhesive layer, a light source unit arranged at a position facing a first side surface of the second light guide plate, and a low refractive index layer interposed in a part of a region between the second light guide plate and the second adhesive layer and having a refractive index lower than that of the first light guide plate, and a thickness of the low refractive index layer is larger than 800 nm.

### BRIEF DESCRIPTION OF DRAWINGS

FIG. 1 is a perspective view showing an example of a transparent display device according to an embodiment;

FIG. 2 is a cross-sectional view taken along the line A-A in FIG. 1;

FIG. 3 is a planar layout diagram showing a pattern of a low refractive index layer;

FIG. 4 is a schematic diagram for describing a state of total reflection of light;

FIG. 5 is a schematic diagram for describing a state of reflection in a comparative example;

FIG. 6 is a schematic diagram for describing a state of total reflection in the transparent display device according to the embodiment; and

FIG. 7 is a graph showing a relationship of a thickness of a low refractive index layer, a wavelength of light, and reflectivity.

### DETAILED DESCRIPTION OF THE INVENTION

Hereinafter, each embodiment of the present invention will be described with reference to drawings. Note that the disclosure is merely an example, and it is a matter of course that any alteration that is easily made by a person skilled in the art while keeping a gist of the present invention is included in the range of the present invention. In addition, the drawings schematically illustrate a width, a thickness, a shape, and the like of each portion as compared with actual aspects in order to make the description clearer, but these are merely examples and do not limit the interpretation of the present invention. Further, the same elements as those described in relation to the foregoing drawings are denoted by the same or related reference characters in this specification and the respective drawings, and detailed descriptions thereof will be omitted as appropriate.

In the following embodiment, a liquid crystal display device configured to display images by using the scattering of visible light caused by liquid crystal molecules will be described as an example of a display panel used in combination with a glass plate.

Further, a liquid crystal display device is a device that forms a display image by changing the orientation of molecules contained in a liquid crystal layer, but it requires a light source. In the embodiment described below, a light source is provided separately from a display panel. Therefore, the display panel and the light source module that supplies visible light to the display panel will be separately described below.

### Embodiment

### <Structure of Transparent Display Panel>

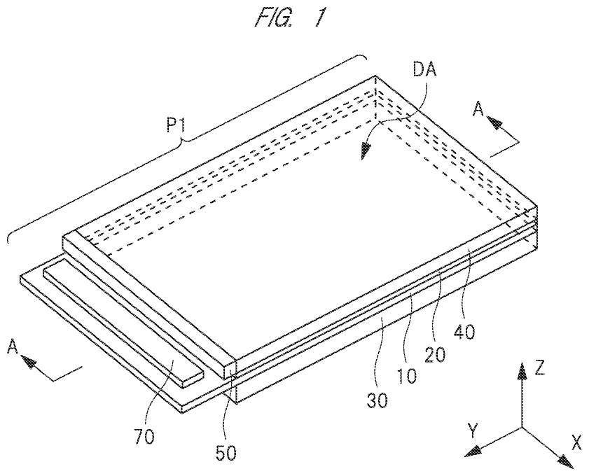

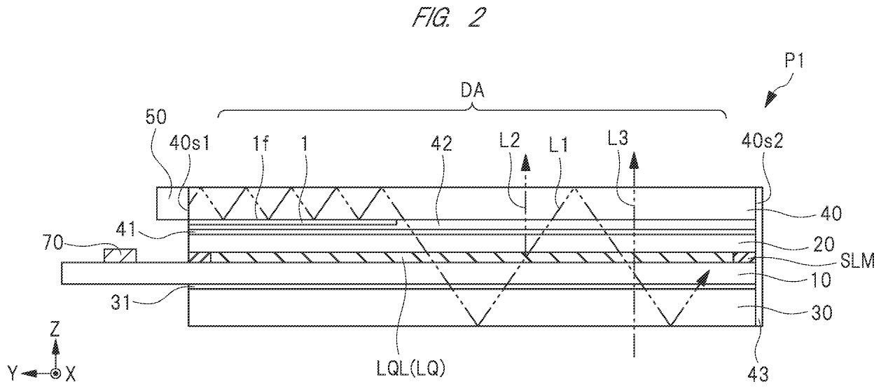

First, features of a so-called transparent display panel will be described. FIG. 1 is a perspective view showing an example of a transparent display panel (transparent display device) which is a display device according to the present embodiment. In the following drawings including FIG. 1, the direction along the thickness direction of a display panel P1 is defined as the Z direction, the extending direction of one side of the display panel P1 in the X-Y plane orthogonal to the Z direction is defined as the X direction, and the direction intersecting the X direction in the X-Y plane is defined as the Y direction. FIG. 2 is a cross-sectional view taken along the line A-A in FIG. 1.

As shown in FIG. 1, the display panel P1 according to the present embodiment includes a substrate (array substrate) 10, a substrate (counter substrate) 20, a light guide plate (referred to also as a first light guide plate or a first cover glass) 30, a light guide plate (referred to also as a second light guide plate or a second cover glass) 40, a light source unit 50, and a drive circuit 70.

When configured as a display device, for example, a control circuit, a flexible substrate connected to the display panel P1, and a housing are provided in some cases in addition to each component in the display panel P1 shown in FIG. 1. Illustration of components other than those of the display panel P1 is omitted in FIG. 1.

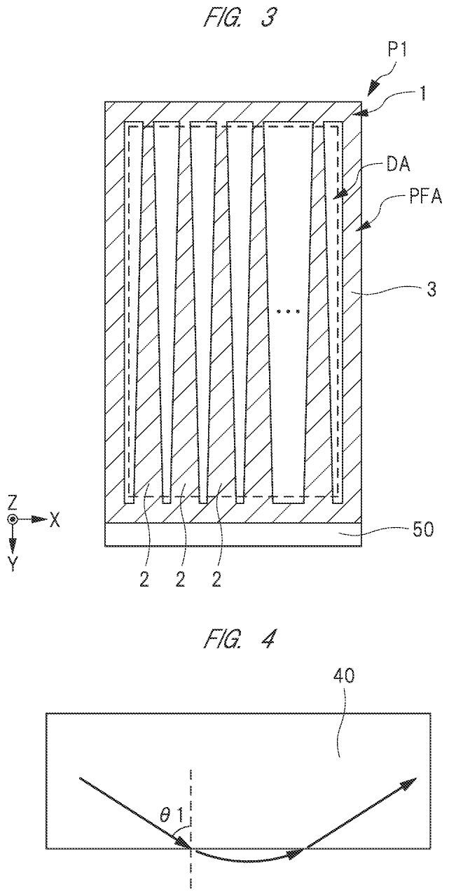

The display panel P1 has a display region DA in which images are formed in accordance with input signals supplied from outside. Also, the display panel P1 has a peripheral region PFA (see FIG. 3) that surrounds the display region DA in plan view. Although the display region DA of the display panel P1 shown in FIG. 1 is a rectangle, the display region DA may have a shape other than a rectangle such as a polygon or a circle. The display region DA is an effective region where the display panel P1 displays images in plan view showing the display screen. Each of the substrate 10, the substrate 20, the light guide plate 30, and the light guide plate 40 is located at a position overlapping the display region DA in plan view. In the example shown in FIG. 1, the drive circuit 70 is mounted on the substrate 10, and the light source unit 50 is provided so as to face a side surface 40s1 of the light guide plate 40. However, the position to mount the light source unit 50 is not limited to this as long as light can be emitted from the light source unit 50 into the light guide plate 40 through the side surface 40s1 of the light guide plate 40. For example, the light source unit 50 may be mounted on the substrate 10. The light source unit 50 includes, for example, a plurality of light emitting diode elements.

First, a light path of the light emitted from the light source unit 50 in the display panel P1 shown in FIG. 2 will be described. As shown in FIG. 2, the display panel P1 includes the substrate 10 and the substrate 20 bonded so as to face each other with a liquid crystal layer LQL interposed therebetween. The substrate 10 and the substrate 20 are arranged in the Z direction corresponding to the thickness direction of the display panel P1. In other words, the substrate 10 and the substrate 20 face each other in the thickness direction of the display panel P1 (Z direction). The substrate 10 has a front surface (main surface, surface) facing the liquid crystal layer LQL. Also, the substrate 20 has a back surface (main surface, surface) facing the front surface of the substrate 10 (and the liquid crystal layer LQL).

The substrate 10 is an array substrate on which a plurality of transistors (transistor elements) as switching elements (active elements) is arranged in an array. This transistor is, for example, a TFT (Thin Film Transistor). Also, the substrate 20 is a substrate provided on a side closer to a display screen with respect to the substrate 10 serving as an array substrate. The substrate 20 can be referred to also as a counter substrate in the sense that it is arranged so as to face the array substrate.

The liquid crystal layer LQL containing liquid crystal LQ is located between the front surface of the substrate 10 and the back surface of the substrate 20. The liquid crystal layer LQL is an optical modulation element. The display panel P1 has a function of modulating light passing therethrough by controlling the state of an electric field formed around the liquid crystal layer LQL via the above-described switching element. The display region DA of the substrate 10 and the substrate 20 overlaps the liquid crystal layer LQL in plan view.

Further, the substrate 10 and the substrate 20 are adhered together via a sealing portion (sealing material) SLM. As shown in FIG. 2, the sealing portion SLM is arranged so as to surround the display region DA in plan view. Namely, the liquid crystal layer LQL is located on an inner side of the sealing portion SLM. The sealing portion SLM functions as a seal that seals liquid crystal between the substrate 10 and the substrate 20. Further, the sealing portion SLM functions as an adhesive for adhering the substrate 10 and the substrate 20 together.

The light guide plate 30 is adhered and fixed on the back surface of the substrate 10 via an adhesive layer 31. Also, the light guide plate 40 is adhered and fixed on the front surface of the substrate 20 via an adhesive layer 41 and a protective film 42 in this order. The light guide plate 30 has a front surface facing the back surface of the substrate 10 and a back surface on the opposite side of the front surface. The light guide plate 30 is adhered and fixed to the substrate 10 via the adhesive layer 31. At least in the display region DA, the gap between the light guide plate 30 and the substrate 10 is filled with the adhesive layer 31. In the example shown in FIG. 2, the adhesive layer 31 is adhered to the entire front surface of the light guide plate 30. The protective film 42 has a back surface facing the front surface of the substrate 20 and a front surface on the opposite side of the back surface.

The light guide plate 40 has a back surface facing the front surface of the substrate 20 and a front surface on the opposite side of the back surface. In addition, the light guide plate 40 has the side surface 40s1 facing the light source unit 50 and a side surface 40s2 located on the opposite side of the side surface 40s1. Each of the side surface 40s1 and the side surface 40s2 is a surface that connects the back surface and the front surface of the light guide plate 40 between the back surface and the front surface of the light guide plate 40. Each of the side surface 40s1 and the side surface 40s2 is a surface along a direction (Z direction) perpendicular to the back surface and the front surface of the light guide plate 40, respectively. The light guide plate 40 is adhered and fixed to the substrate 20 via the adhesive layer 41. At least in a part of the display region DA, the gap between the light guide plate 40 and the substrate 20 is filled with the adhesive layer 41 and the protective film 42. Namely, the light guide plate 40 is bonded to the substrate 20 via the protective film 42 and the adhesive layer 41.

A low refractive index layer (transparent layer) 1 is interposed in a part of the region between the back surface of the light guide plate 40 and the front surface of the protective film 42. The protective film 42 covers a back surface of the low refractive index layer 1 and is bonded to the substrate 20 via the adhesive layer 41. The low refractive index layer 1 has the back surface facing the front surface of the substrate 20 and a front surface 1f on the opposite side of the back surface. As will be described later with reference to FIG. 3, the low refractive index layer 1 does not cover the entire front surface of the adhesive layer 41 in the display region DA, but covers the front surface of the adhesive layer 41 in a predetermined range of the display region DA. In the cross section shown in FIG. 2, the low refractive index layer 1 is in contact with the back surface of the light guide plate 40 in the predetermined range in the display region DA, and the protective film 42 is adhered to the back surface of the light guide plate 40 in a range different from the predetermined range in the display region DA. The low refractive index layer 1 has a lower refractive index than any of the substrate 10, the substrate 20, the light guide plate 30, the light guide plate 40, the adhesive layer 31, and the adhesive layer 41.

Each of the adhesive layer 31 and the adhesive layer 41 is made of a transparent resin material that can transmit visible light. Examples of the adhesive layer 31 and the adhesive layer 41 capable of transmitting visible light include a transparent adhesive sheet referred to as OCA (Optical Clear Adhesive) formed in a sheet shape, an OCR (Optical Clear Resin) used by curing a liquid transparent adhesive, and the like. The protective film 42 is also made of a transparent material that can transmit visible light. The thickness of the protective film 42 is, for example, about 1 μm. Also, one of the main features of the present embodiment is that the thickness of the low refractive index layer 1 in the Z direction is larger than 800 nm. Specifically, the thickness of the low refractive index layer 1 is, for example, 1 μm.

In the case of the display panel P1 shown in FIG. 2, in order to ensure visible light transmittivity of the front and back surfaces, the light source unit 50 is arranged at a position that does not overlap the display region DA. Further, the display panel P1 has a mechanism to deliver light to the side surface 40s2 on the opposite side of the side surface 40s1 facing the light source unit 50 by reflecting light source light L1 by use of the difference in refractive index between the light guide plate 30, the light guide plate 40, the substrate 10, and the substrate 20 and the surrounding air layer. The side surface of the display panel P1 including the side surface 40s2, that is, the side surface of the stacked body including the substrate 10, the substrate 20, the light guide plate 30, the light guide plate 40, the adhesive layer 31, the adhesive layer 41, and the sealing portion SLM has a mirror 43 bonded such that a mirror surface thereof faces the side surface.

In the case of a display panel in which the light source light enters from the side surface of the light guide plate to illuminate the entire display region as described above, a phenomenon in which the brightness of the region far from the light source unit is lower than the brightness of the region close to the light source unit in the display region is observed. Here, this phenomenon is referred to as a brightness gradient phenomenon. In order to suppress such a brightness gradient phenomenon, in the display panel P1 of the present embodiment, the low refractive index layer 1 is provided near the light source unit 50. Since the refractive index of the low refractive index layer 1 is lower than the refractive index of the adhesive layer 41, the critical angle at which the light source light L1 passing through the light guide plate 40 is totally reflected on the front surface of the low refractive index layer 1 is smaller than the critical angle at which the light is totally reflected on the front surface of the adhesive layer 41. Therefore, in the vicinity of the light source unit 50 where the low refractive index layer 1 is formed, the light source light L1 reaching the liquid crystal layer LQL and the light guide plate 30 can be reduced. In other words, it is possible to obtain an effect that the region where the light source light L1 illuminates the display panel P1 can be brought forward to a position far from the light source unit 50. In this way, the brightness gradient phenomenon can be suppressed.

Next, a pattern of the low refractive index layer 1 will be described using the planar layout shown in FIG. 3. FIG. 3 shows the light source unit 50 in addition to the low refractive index layer 1. In FIG. 3, hatching is attached to the low refractive index layer 1 to make the pattern shape easier to understand.

As shown in FIG. 3, the display panel P1 has the annular peripheral region PFA and the display region DA surrounded by the peripheral region PFA in plan view. The boundary between the peripheral region PFA and the display region DA is indicated by a dashed line in FIG. 3. The low refractive index layer 1 has a frame portion 3 which is a rectangular annular pattern formed in the peripheral region PFA in plan view and a plurality of band portions 2 which extends in the Y direction in the display region DA. The band portion 2 is a pattern extending in the Y direction. Namely, the band portion 2 extends from the side closer to the side surface 40s1 of the light guide plate 40 facing the light source unit 50 shown in FIG. 2 toward the side surface 40s2 on the opposite side. The band portion 2 is integrated with the frame portion 3 at both ends in the longitudinal direction. The plurality of band portions 2 is arranged in the X direction so as to be separated from each other. The X direction and the Y direction are directions along the back surface of the light guide plate 40.

The width of each of the plurality of band portions 2 in the lateral direction is larger on the side of the light source unit 50 than that on the opposite side of the light source unit 50 in plan view. In other words, the width of the band portion 2 becomes smaller as it gets away from the light source unit 50. Each of the plurality of band portions 2 has the same planar shape, and is arranged at an equal interval in the X direction. The constant distance X1 with which the plurality of band portions 2 is arranged in the X direction is 100 to 200 μm or more. Since each band portion 2 has a large width in the vicinity of the light source unit 50, the light source light L1 that has entered the light guide plate 40 from the light source unit 50 is more likely to be totally reflected in the region close to the light source unit 50 than in the region far from the light source unit 50. Therefore, since the light source light L1 that reaches the liquid crystal layer LQL and the light guide plate 30 can be reduced in the vicinity of the light source unit 50, the brightness gradient phenomenon can be suppressed.

The constant distance X1 with which the plurality of band portions 2 is arranged is, for example, the distance from the center of a predetermined band portion 2 to the center of another band portion adjacent to the band portion 2 in the X direction.

Here, the refractive index of each of the adhesive layer 31 and the adhesive layer 41 is 1.474. The refractive index of each of the substrate 10 and the substrate 20 is 1.51. The refractive index of the light guide plate 30 is 1.470 to 1.51. The refractive index of the light guide plate 40 is 1.470. The refractive index of the protective film 42 is 1.500. The refractive index of the low refractive index layer 1 is 1.410.

Namely, as schematically indicated by a two-dot-dashed line in FIG. 2, the light source light L1 emitted from the light source unit 50 is propagated in the direction away from the side surface 40s1, while being reflected by the back surface of the light guide plate 30 and the front surface of the light guide plate 40. At this time, of the light source light L1 incident on the surface of the low refractive index layer 1 from the side of the light guide plate 40 or the side of the light guide plate 30, the light whose incident angle is larger than the critical angle is totally reflected. Thereafter, the light source light L1 reflected by the mirror 43 is propagated toward the opposite side (toward the side surface of the display panel P1 including the side surface 40s1) while being reflected by the back surface of the light guide plate 30 and the front surface of the light guide plate 40.

The liquid crystal LQ is polymer dispersed liquid crystal (PDLC) and contains liquid crystalline polymer and liquid crystal molecules. The orientation direction of the liquid crystalline polymer hardly changes regardless of whether there is the electric field. On the other hand, the orientation direction of the liquid crystal molecules changes in accordance with the electric field when the voltage higher than the threshold is being applied to the liquid crystal LQ. In the state where the voltage is not applied to the liquid crystal LQ, the optical axes of the liquid crystalline polymer and the liquid crystal molecules are parallel to each other, and the light source light L1 that has entered the liquid crystal layer LQL passes almost without being scattered in the liquid crystal layer LQL (transparent state). In the state where the voltage is applied to the liquid crystal LQ, the optical axes of the liquid crystalline polymer and the liquid crystal molecules intersect each other, and the light source light L1 that has entered the liquid crystal LQ is scattered in the liquid crystal layer LQL (scattering state).

The display panel P1 controls the transparent state and the scattering state by controlling the orientation of the liquid crystal LQ in the propagation path of the light source light L1. In the scattering state, the light source light L1 is emitted as emission light L2 by the liquid crystal LQ to the outside of the display panel P1 from the front surface side of the light guide plate 40 and the back surface side of the light guide plate 30. The emission light L2 and background light L3 are visually recognized by, for example, an observer on the side of the front surface of the light guide plate 40. The observer can recognize the emission light L2 and the background light L3 in combination. In this way, the observer using a transparent display panel can recognize the display image and the background superimposed on each other.

### Effect of Present Embodiment

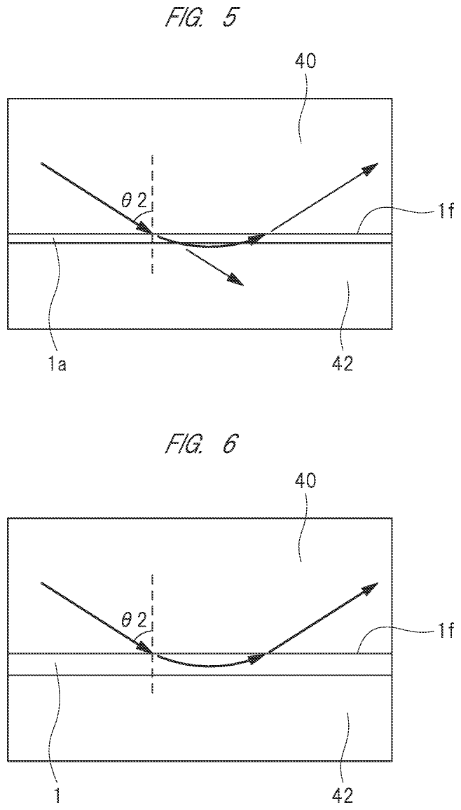

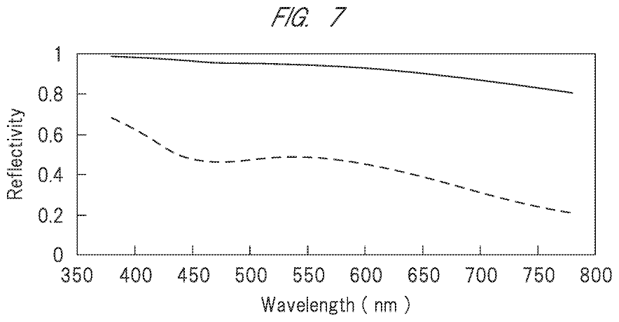

A state of total reflection will be described below with reference to FIG. 4, FIG. 5, and FIG. 6. FIG. 4 is a schematic diagram for describing a state of total reflection of light. FIG. 5 is a schematic diagram for describing a state of total reflection of light in a comparative example. FIG. 6 is a schematic diagram for describing a state of total reflection of light according to the present embodiment. In FIG. 4, FIG. 5, and FIG. 6, the light path is indicated by an arrow. Also, though FIG. 4, FIG. 5, and FIG. 6 are cross-sectional views, hatching is omitted in order to make the light path easier to understand.

FIG. 4 shows only the light guide plate 40 as an example. FIG. 4 shows how the light travels when the light traveling in the light guide plate 40 is totally reflected by the back surface of the light guide plate 40. Here, the incident angle θ1 of the light is equal to or larger than the critical angle at which the total reflection occurs on the back surface of the light guide plate 40. It is not that no light comes out of the light guide plate 40 when the total reflection occurs, but a part of it temporarily leaks out of the light guide plate 40 and then returns into the light guide plate 40 after passing through the back surface of the light guide plate 40. As described above, when light enters at an incident angle at which total reflection should occur, a part of the light leaks out toward the material with a lower refractive index. The light that leaks out in this way is referred to as evanescent light.

Next, a case where a low refractive index layer 1a with a relatively small thickness is in contact with the light guide plate 40 will be described as a comparative example with reference to FIG. 5. Here, the incident angle θ2 of the light that enters the front surface 1f of the low refractive index layer 1a from the light guide plate 40 is equal to or larger than the critical angle at which the total reflection occurs when the light enters the front surface 1f of the low refractive index layer 1a from the light guide plate 40.

At this time, a part of the light that reaches the interface between the light guide plate 40 and the low refractive index layer 1a from the light guide plate 40 leaks out into the low refractive index layer 1a near the back surface of the light guide plate 40 and then tries to return into the light guide plate 40. However, if the thickness of the low refractive index layer 1a is 800 nm or less, a part of the light that comes out of the back surface of the light guide plate 40 enters the protective film 42 from the back surface of the low refractive index layer 1a and travels straight in the protective film 42 in the direction different from that toward the light guide plate 40. Even if a part of the light that leaks out of the back surface of the light guide plate 40 returns into the light guide plate 40, the other part of the light travels toward the protective film 42, and thus the total reflection expected by providing the light guide plate 40 does not occur. Namely, since the reflectivity by the low refractive index layer 1a is lowered, the brightness gradient phenomenon cannot be sufficiently suppressed.

In the comparative example described above, the small thickness of the low refractive index layer 1a causes the reduction of the reflectivity. A problem of the reduction of the reflectivity by the low refractive index layer 1a arises when the thickness of the low refractive index layer 1a is 800 nm or less.

Therefore, in the present embodiment, the thickness of the low refractive index layer 1 is sufficiently increased as shown in FIG. 6 so as to suppress the light from leaking out. Specifically, the thickness of the low refractive index layer 1 is larger than 800 nm. In this way, a part of the light that reaches the interface between the light guide plate 40 and the low refractive index layer 1 from the light guide plate 40 at the incident angle θ2 leaks out into the low refractive index layer 1 from the back surface of the light guide plate 40 and then returns into the light guide plate 40. At this time, since the low refractive index layer 1 has a sufficient thickness such that the light that leaks out into the low refractive index layer 1 does not enter the protective film 42, the leakage of light into the protective film 42 at the time when the total reflection occurs can be suppressed. Accordingly, in the present embodiment, the desired effect of suppressing the brightness gradient phenomenon can be obtained by providing the low refractive index layer 1, and it is thus possible to improve the performance of the display device.

FIG. 7 shows a graph of a relationship of a wavelength of light (horizontal axis) and reflectivity of light (vertical axis) when the light is reflected as a result of simulation conducted by the inventor of this application. FIG. 7 shows the reflectivity when light enters the low refractive index layer from the light guide plate at an angle (here, 75 degrees) equal to or larger than the critical angle at which the total reflection occurs. The graph of the simulation using the display panel of the comparative example in which the thickness of the low refractive index layer is 300 nm is indicated by a dashed line in FIG. 7. Also, the graph of the simulation using the display panel in which the thickness of the low refractive index layer is 900 nm is indicated by a solid line in FIG. 7. Namely, the graph indicated by the solid line shows the simulation result in the case where the thickness of the low refractive index layer is set larger than 800 nm as in the present embodiment.

As shown in FIG. 7, the reflectivity of light is relatively low in the graph of the comparative example indicated by the dashed line, whereas the reflectivity is higher than that of the comparative example in the graph indicated by the solid line. It can be seen that the reflectivity of 80% or more can be obtained even on the long wavelength side and the favorable reflection characteristics can be obtained in the graph indicated by the solid line. From the viewpoint of increasing the reflectivity, the thickness of the low refractive index layer is preferably 1 μm or more. From the optical viewpoint, the effect of the present embodiment can be obtained as long as the thickness of the low refractive index layer is larger than 800 nm, but it is conceivable that the upper limit of the thickness of the low refractive index layer is 5 μm due to the restriction in the method of forming the low refractive index layer.

Here, when the thickness of the low refractive index layer is relatively large, diffraction of light by the low refractive index layer may become a problem. This is the problem in which the external light and the diffracted light are separate when the constant distance X1 with which the band portions 2 (see FIG. 3) of the low refractive index layer are arranged is relatively small and the diffraction image is visually recognized by the observer, whereby the display quality on the display panel is deteriorated. However, if the constant distance X1 with which the plurality of band portions 2 is arranged in the X direction described with reference to FIG. 3 is 100 μm or more, even in the case where the low refractive index layer 1 has a thickness larger than 800 nm as in the present embodiment, the diffraction image is not visually recognized and does not pose a problem because the external light and the diffracted light almost overlap each other. From the viewpoint of making the diffraction image less noticeable, it is more desirable that the distance X1 is 200 μm or more.

Although the embodiment and typical modifications have been described above, the above-described technique can be applied to various modifications other than the illustrated modifications. For example, the above-described modifications may be combined with each other.

A person having ordinary skill in the art can make various alterations and corrections within a range of the idea of the present invention, and it is interpreted that the alterations and corrections also belong to the scope of the present invention. For example, the embodiment obtained by performing addition or elimination of components or design change or the embodiment obtained by performing addition or reduction of process or condition change to the embodiment described above by a person having an ordinary skill in the art is also included in the scope of the present invention as long as it includes the gist of the present invention.

The present invention can be applied to display devices and electronic devices incorporating display devices.

What is claimed is:

1. A display device comprising:
a first substrate having a first front surface and a first back surface on an opposite side of the first front surface;
a second substrate having a second back surface facing the first front surface and a second front surface on an opposite side of the second back surface;
a liquid crystal layer arranged between the first front surface of the first substrate and the second back surface of the second substrate;
a first light guide plate adhered and fixed to the first back surface of the first substrate via a first adhesive layer;
a second light guide plate adhered and fixed to the second front surface of the second substrate via a second adhesive layer;
a light source unit arranged at a position facing a first side surface of the second light guide plate; and
a low refractive index layer interposed in a part of a region between the second light guide plate and the second adhesive layer and having a refractive index lower than that of the first light guide plate,
wherein a thickness of the low refractive index layer is larger than 800 nm.

2. The display device according to claim 1,
wherein the thickness of the low refractive index layer is 1 μm or more.

3. The display device according to claim 1,
wherein the thickness of the low refractive index layer is 5 μm or less.

4. The display device according to claim 1,
wherein the low refractive index layer has a plurality of patterns extending in a first direction along a back surface of the second light guide plate and arranged in a second direction which is along the back surface of the second light guide plate and intersects the first direction, and
wherein a constant distance with which the plurality of patterns is arranged in the second direction is 100 μm or more.
